(19) United States
(12) Patent Application Publication
(10) Pub. No.: US 2024/0328871 A1
(43) Pub. Date: Oct. 3, 2024

(54) UTILIZATION OF TEMPERATURE DATA FROM A TEMPERATURE SENSING SYSTEM OF AN ELECTRONIC DEVICE

(71) Applicant: Apple Inc., Cupertino, CA (US)

(72) Inventors: Imam uz ZAMAN, Santa Clara, CA (US); Ashkan OJAGHI, Milpitas, CA (US); Mathieu CHARBONNEAU-LEFORT, San Jose, CA (US); Ueyn L. BLOCK, Menlo Park, CA (US)

(21) Appl. No.: 18/615,445

(22) Filed: Mar. 25, 2024

Related U.S. Application Data
(60) Provisional application No. 63/493,287, filed on Mar. 30, 2023.

(51) Int. Cl. G01K 13/20; G01K 1/02; G01K 1/16; G01K 3/14

(52) U.S. Cl. CPC G01K 13/20; G01K 1/026; G01K 1/16; G01K 3/14

(57) ABSTRACT

This relates generally to systems and processes (e.g., algorithm(s), application(s), and device(s)) that use temperature information, such as temperature gradient data (e.g., spatial temperature gradients and/or temporal temperature gradients), for detecting a physiological state of a user, a portion of the user on which the user wears an electronic device, an orientation of the electronic device on the user, and/or skin thermal properties for body temperature sensing, for refining or improving an optical sensor calibration, and/or for improving a photoplethysmogram sensor.

### CROSS-REFERENCE TO RELATED APPLICATIONS

This application claims the benefit of U.S. Provisional Application No. 63/493,287, filed Mar. 30, 2023, the content of which is herein incorporated by reference in its entirety for all purposes.

### FIELD OF THE DISCLOSURE

This relates generally to electronic devices including temperature sensing systems, and more particularly to utilization of temperature data from temperature sensing systems of electronic devices.

### BACKGROUND OF THE DISCLOSURE

An electronic device may include sensors, such as a touch sensor and an optical sensor. Another sensor that an electronic device may include is a temperature sensor.

### SUMMARY OF THE DISCLOSURE

This relates generally to systems and processes (e.g., algorithm(s), application(s), and device(s)) that use temperature information, such as temperature gradient data (e.g., spatial temperature gradients and/or temporal temperature gradients), for detecting a physiological state of a user, a portion of the user on which the user wears an electronic device, an orientation of the electronic device on the user, and/or skin thermal properties for body temperature sensing, for refining or improving an optical sensor calibration, and/or for improving a photoplethysmogram sensor. In some examples, an electronic device determines a physiological state of a user, such as active, resting, sleeping, vasoconstriction, or vasodilation state of a user based on temperature gradient (e.g., thermal gradient) data. In some examples, an electronic device determines a portion of the user (e.g., a left wrist, right wrist, or another portion of the user) that the user of the electronic device wears the electronic device based on temperature gradient data, optionally in addition to other sensor data such as data from an accelerometer. In some examples, an electronic device determines an orientation of the electronic device, such as whether a first side or a second side of the electronic device faces a distal side or a proximal side of the user. In some examples, an electronic device determines an orientation of a graphical user interface to-be-displayed on the electronic device based on the orientation of the electronic device that is determined using temperature gradients. In some examples, an electronic device improves a photoplethysmogram sensor by using temperature data, such as by determining, based on the temperature data, information about a user's tissue properties for increasing a calibration and/or accuracy of optical sensors (e.g., optical sources, LEDs, photodetectors, and/or another type of optical sensors). The systems and processes disclosed herein may reduce system errors and user errors in interaction with the electronic device; thus, improving user interaction with the electronic device.

### BRIEF DESCRIPTION OF THE DRAWINGS

FIG. 1 illustrates an electronic device that utilizes temperature data of a temperature sensing system according to some examples of the disclosure.

FIG. 2 illustrates a block diagram of an electronic device that utilizes temperature data of a temperature sensing system according to some examples of the disclosure.

FIG. 3A illustrates an example spatial distribution of temperature sensors of the electronic device of FIG. 1 according to some examples of the disclosure.

FIG. 3B illustrates a graph showing temporal variations of skin spatial temperature gradient based on temperature data of a temperature sensing system of an electronic device according to some examples of the disclosure.

FIG. 4 illustrates a graph showing a Root Mean Square (RMS) estimation of temporal variations of skin temperature gradient based on temperature data of a temperature sensing system of an electronic device according to some examples of the disclosure.

FIG. 5 illustrates a flowchart of a method for determining one or more characteristics of a user using temperature gradients according to some examples of the disclosure.

FIG. 6 illustrates graphs of spatial temperature distribution for different users of the electronic device of FIG. 1 along an axis according to some examples of the disclosure.

FIG. 7 illustrates a flowchart of a method for determining one or more orientations using temperature data according to some examples of the disclosure.

FIG. 8 illustrates a flowchart of a method for determining one or more characteristics using temperature data according to some examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used, and structural changes can be made without departing from the scope of the disclosed examples.

This relates generally to systems and processes (e.g., algorithm(s), application(s), and device(s)) that use temperature information, such as temperature gradient data (e.g., spatial temperature gradients and/or temporal temperature gradients), for detecting a physiological state of a user, a portion of the user on which the user wears an electronic device, an orientation of the electronic device on the user, and/or skin thermal properties for body temperature sensing, for refining or improving an optical sensor calibration, and/or for improving a photoplethysmogram sensor. In some examples, an electronic device determines a physiological state of a user, such as active, resting, sleeping, vasoconstriction, or vasodilation state of a user based on temperature gradient (e.g., thermal gradient) data. In some examples, an electronic device determines a portion of the user (e.g., a left wrist, right wrist, or another portion of the user) that the user of the electronic device wears the electronic device based on temperature gradient data, optionally in addition to other sensor data such as data from an accelerometer. In some examples, an electronic device determines an orientation of the electronic device, such as whether a first side or a second side of the electronic device faces a distal side (e.g., a hand-side of wrist) or a proximal side (e.g., elbow-side of wrist) of the user. In some examples, an electronic device determines an orientation of a graphical user interface to-be-displayed on the electronic device based on the orientation of the electronic device that is determined using temperature gradients. In some examples, an electronic device improves a photoplethysmogram sensor by using temperature data, such as by determining, based on the temperature data, information about a user's tissue properties for increasing a calibration and/or accuracy of optical sensors (e.g., optical sources, LEDs, photodetectors, and/or another type of optical sensors). The systems and processes disclosed herein may reduce system errors and user errors in interaction with the electronic device; thus, improving user interaction with the electronic device.

An electronic device may include a temperature sensing system and may utilize temperature data in accordance with some examples of the disclosure.

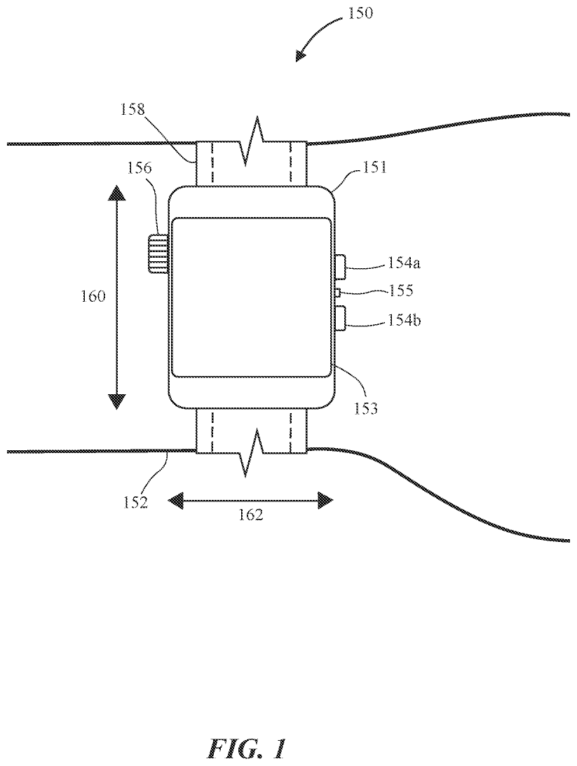

FIG. 1 illustrates an electronic device 150 (e.g., a watch, a wearable device) that utilizes temperature data of a temperature sensing system according to some examples of the disclosure. Electronic device 150 includes a housing 151 (that includes a longitudinal length along axis 160 and a width along axis 162), a touch screen 153, side buttons 154a and 154b that are optionally pressable, a speaker 155 for generating audio, and a digital crown 156 that is optionally rotatable (e.g., about an axis parallel to axis 162) and/or pressable. In some examples, electronic device includes more or less buttons that in the illustrated example. Electronic device 150 is worn on (e.g., in contact with) a portion 152 (e.g., a dorsal side of a left wrist) of a user. In FIG. 1, the user wears electronic device 150 on the dorsal side of the user's left wrist and digital crown 161 faces the proximal side of the user while side buttons 154a and 154b and speaker 155 faces the distal side of the user. Electronic device 150 is coupled to a user via strap 158 (e.g., a fastener). In some examples, various temperature sensors distributed within electronic device 150 detect skin temperatures in various locations along the plane of axis 160 and axis 162. In some examples, one or more temperature sensors are distributed within electronic device 150 to detect skin temperatures in various locations along one or more planes parallel to the plane of axis 160 and axis 162, optionally in addition to the distribution of one or more temperature sensors on the plane of axis 160 and axis 162.

It should be understood that although illustrated and described herein primarily as a wrist worn watch, that the disclosure herein is not so limited. The systems and processes described herein can be implemented in other wearable (e.g., wristband, ring, head-mounted display, etc.) and non-wearable devices (e.g., a mobile telephone, a digital media player, a personal computer, tablet computer, etc.) that optionally include a touch screen and/or optionally includes a temperature sensing system, from which temperature data is utilized in accordance with some examples of the disclosure. For example, a head-mounted display optionally includes a temperature sensing system that detects temperature data near or at temples and/or another portion of a user's forehand and utilizes the temperature data in accordance with some examples of the disclosure. For example, a non-wearable personal computer optionally includes an input surface (e.g., a keyboard, trackpad, touch-sensitive surface, laptop base, tablet, or another input surface) on which the user rests one or more portions of a user such as wrists or fingers and through which a temperature sensing system, including temperature sensors, detects temperature data corresponding to the portion of the user in contact with the input surface, and utilizes the temperature data according to some examples of the disclosure.

It should be understood that the above-described example devices, including electronic device 150, are provided by way of example, and other devices, optionally including a non-touch sensitive display, no display, or a touch-sensitive display, can include a temperature sensing system, from which temperature data is utilized in accordance with some examples of the disclosure.

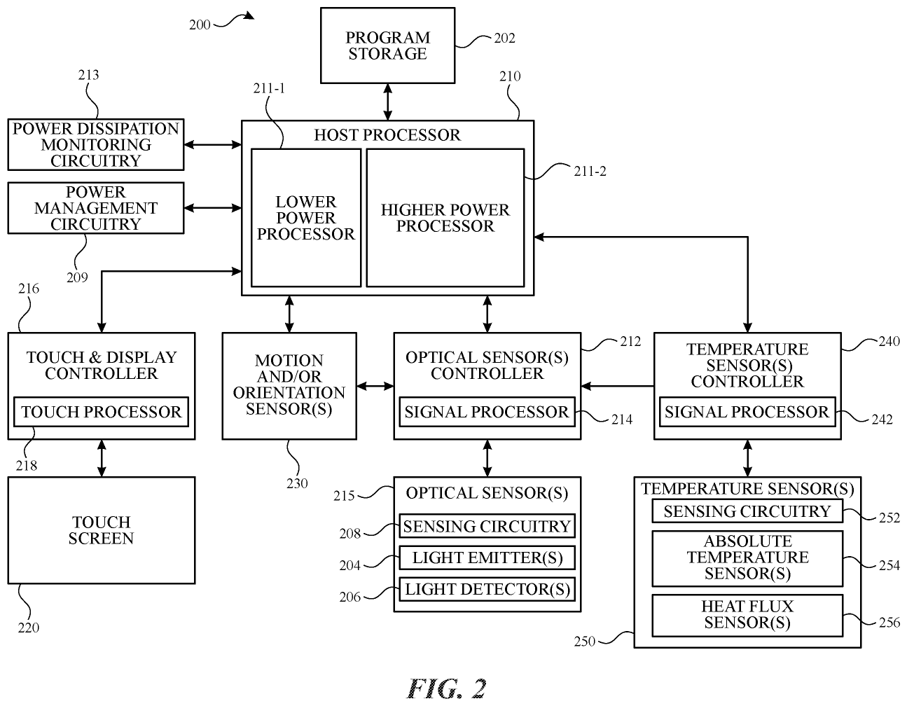

FIG. 2 illustrates a block diagram of a computing system 200 that utilizes temperature data of a temperature sensing system according to some examples of the disclosure. Computing system 200 optionally corresponds to electronic device 150 of FIG. 1 and/or may be implemented in other electronic devices, such as the various types of electronic devices discussed above.

Computing system 200 includes a host processor 210 (or more than one processor) programmed to (configured to) execute instructions and to carry out operations associated with computing system 200. For example, using instructions retrieved from a program storage 202, host processor 210 can control the reception and manipulation of input and output data between components of computing system 200. Host processor 210 can be a single-chip processor (e.g., an application specific integrated circuit) or can be implemented with multiple components/circuits. For example, FIG. 2 illustrates the host processor 210 including a relatively lower power processor 211-1 and a relatively higher power processor 211-2, as described in more detail herein.

In some examples, host processor 210, together with an operating system can operate to execute computer code/programs, and produce and/or use data. The computer code and data can reside within the program storage 202 that can be operatively coupled to host processor 210. Program storage 202 can generally provide a place to hold data used by computing system 200. Program storage 202 can be any non-transitory computer-readable storage medium. By way of example, program storage 202 can include Read-Only Memory (ROM), Random-Access Memory (RAM), hard disk drive and/or the like. The computer code and data could also reside on a removable storage medium and loaded or installed onto computing system 200 when needed. Removable storage mediums include, for example, CD-ROM, DVD-ROM, Universal Serial Bus (USB), Secure Digital (SD), Compact Flash (CF), Memory Stick, Multi-Media Card (MMC) and/or a network component.

As described herein, in some examples, host processor 210 can represent multiple processors, such as lower power processor 211-1 and higher power processor 211-2. Lower power processor 211-1 and higher power processor 211-2 can represent separate processing chips, each with independent timing and power requirements. For example, lower power processor 211-1 can operate using a first clock signal and at a first power level that allows processor 211-1 to remain operational (“on”) across most or all operating modes of computing system 200 (e.g., a sleep mode, awake mode, idle mode, etc.). By contrast, higher power processor 211-2 can operate using a second clock signal (e.g., a higher frequency clock), different from the first, or at a second power level, higher than the first. Because of the higher power requirements of higher power processor 211-2, host processor 210 (e.g., an operating system on host processor 210) can selectively disable, or power down higher power processor 211-2 or otherwise throttle its power consumption during certain operating modes of computing system 200 (e.g., a power saving mode, sleep mode, etc.). In some examples, as described herein, the higher power processor 211-1 can be powered down or otherwise throttle its power consumption to enable temperature measurements without error introduced by the power dissipation by higher power processor 211-1.

Lower power processor 211-1 and/or higher power processor 211-2 can interface with various sensors of computing system 200 including a touch sensor panel and/or a touch screen 220 (via touch and display controller 216), motion and/or orientation sensor(s) 230, optical sensor(s) 215 (via optical sensor controller 212), and temperature sensor(s) 250 (via temperature sensor(s) controller 240). In some examples, lower power processor 211-1 can operate in a sleep mode or a power-saving mode, while higher power processor 211-2 is powered down. In some examples, lower power processor 211-1 can change an operating mode of computing system 200 or otherwise cause higher power processor 211-2 to be powered on (e.g., when wake up conditions are detected).

Computing system 200 can also include power management circuitry 209 and/or power dissipation monitoring circuitry 213. Host processor 210 (e.g., lower power processor 211-1 and/or higher power processor 211-2) can be coupled to power management circuitry 209 and/or power dissipation monitoring circuitry 213. Power management circuitry 209 can regulate power delivery from power supply circuitry (e.g., a battery, or another power source of computing system 200) to various components of computing system 200 (e.g., sensors, processors, antennas, displays, etc.). As an example, power management circuitry 209 can interrupt or throttle power delivery to components that generate heat within computing system 200 (e.g., heat-generating components, thermal aggressors), especially to ensure proper performance, keep the computing system in safe operating conditions, or during temperature measurements that may be sensitive to heat from such components. Power management circuitry 209 can monitor temperatures inside a housing of computing system 200 (e.g., housing 151 of FIG. 1) and/or temperatures outside the housing. In some examples, power management circuitry 209 provides control signals to inline switches coupled between the power supply circuitry of computing system 200 and various components of computing system 200, where the control signals determine an amount of current or power that can be delivered to the respective components. As an example, power management circuitry 209 can provide a first control signal to a switch interposed between a battery power source of computing system 200 and touch screen 220, such that the first control signal limits the amount of power or current delivered to the touch screen by the battery power source. As another example, power management circuitry 209 can provide a second control signal to a switch interposed between a battery power source of computing system 200 and antenna circuitry (not shown) of the system, such that the second control signal interrupts power delivery or current flow between the battery power source and the antenna circuitry.

Power dissipation monitoring circuitry 213 can monitor power supply circuitry of computing system 200, and can regulate power delivery from the power supply circuitry (not shown) to various components of computing system 200 (e.g., by sending instructions to power management circuitry 209). In some examples, power dissipation monitoring circuitry 213 includes a sensor coupled to the power supply circuitry (e.g., battery) of computing system 200. The sensor can measure power drawn by components of computing system 200 from the power supply circuitry (e.g., a battery of computing system 200). In some examples, the power draw by components of the computing system 200 can be estimated based on a current draw from the power supply circuitry. In some examples, the power drawn can be estimated on a device basis (e.g., estimated current draw from the battery).

In some examples, computing system 200 includes one or more input/output (I/O) controllers that can be operatively coupled to host processor 210. I/O controllers can be configured to control interactions with one or more I/O devices (e.g., touch sensor panels, display screens, touch screens, physical buttons, dials, slider switches, joysticks, or keyboards). I/O controllers can operate by exchanging data between host processor 210 and the I/O devices that desire to communicate with host processor 210. The I/O devices and I/O controller can communicate through a data link. The data link can be a unidirectional or bidirectional link. In some cases, I/O devices can be connected to I/O controllers through wireless connections. A data link can, for example, correspond to any wired or wireless connection including, but not limited to, PS/2, Universal Serial Bus (USB), Firewire, Thunderbolt, Wireless Direct, IR, RF, Wi-Fi, BLUETOOTH, or the like.

In the illustrated example, computing system 200 includes a temperature sensor(s) controller 240 operatively coupled to host processor 210 and to temperature sensor(s) 250 (e.g., one or more temperature sensors). Also, the temperature sensor controller 240 is coupled to optical sensor controller 212. The temperature sensor(s) 250 include one or more absolute temperature sensor(s) 254, one or more heat flux sensor(s) 256, and sensing circuitry 252 (e.g., analog and/or digital circuitry to: measure signals at the one or more absolute temperature sensor(s) 254 and/or one or more heat flux sensor(s) 256; provide processing (e.g., amplification, filtering, level-shifting); and convert analog signals to digital signals for performing temperature and/or heat-flux sensing measurements). As an example, the one or more absolute temperature sensor(s) 254 and one or more heat flux sensor(s) 256 may be configured to measure temperature at various locations within the computing system 200, including at least one location or region inside the wearable device different than a location or region in which an absolute temperature sensor is disposed for the computing system 200. These temperatures and/or heat flux measurements can be used to measure temperature characteristics of the device under various modes of operation (e.g., to estimate when temperatures within a device are approaching unsafe or unsustainable levels), to estimate ambient temperatures outside the device, or to estimate a physiological signal associated with a user (e.g., a body temperature of the user). In some examples, the temperatures sensor(s) 250 include one or more absolute temperature sensor(s) 254 without including one or more heat flux sensor(s) 256. In some examples, the temperature sensor(s) 250 include one or more heat flux sensor(s) 256, without including one or more absolute temperatures sensor(s) 254.

Measured raw data from the absolute temperature sensors 254, heat flux sensor(s) 256, and sensing circuitry 252 can be transferred to the host processor 210 (via temperature sensor(s) controller 240), and the host processor 210 can perform signal processing to estimate internal or external temperatures and/or to estimate physiological signals (e.g., body temperature associated with the user). Host processor 210 and/or temperature sensor controller 240 can operate temperature sensor(s) 250 to measure temperature values associated with computing system 200, and to estimate temperature values associated with the environment external to the system. In some examples, temperature sensor(s) controller 240 can include signal processor 242 to sample, filter, and/or convert (from analog to digital) signals generated by various temperature sensor(s) 250, which can be positioned at different locations within a housing for the computing system 200. In some examples, signal processor 242 is a digital signal processing circuit such as a digital signal processor (DSP). In some examples, the analog data measured by the temperature sensor(s) 250 can be converted into digital data by an analog to digital converter (ADC). In some examples, the digital data from the temperature sensors can be stored for processing in a buffer (e.g., a first-in-first-out (FIFO) buffer) or other volatile or non-volatile memory (not shown) in temperature sensor(s) controller 240. In some examples, host processor 210 and/or temperature sensor(s) controller 240 can store the raw data and/or processed information in memory (e.g., ROM or RAM) for historical tracking or for future diagnostic purposes. In some examples, the temperature sensor(s) 250 can include a negative temperature coefficient (NTC) temperature sensor, a resistance temperature detector (RTD), digital temperature sensor, optical temperature sensors, thin film, and/or a diode based temperature sensor.

In the illustrated example, computing system 200 includes an optical sensor(s) controller 212 operatively coupled to host processor 210 and to one or more optical sensors 215. As illustrated, in some examples, the optical sensor(s) 211 include light emitter(s) 204, light detector(s) 206, and sensing circuitry 208 (e.g., analog circuitry to drive emitters and measure signals at the detector, provide processing (e.g., amplification, filtering), and convert analog signals to digital signals). As an example, light emitters 204 and light detectors 206 can be configured to generate and emit light into a user's skin and detect returning light (e.g., reflected and/or scattered) to measure a physiological signal (e.g., a photoplethysmogram (PPG) signal), respectively. In some examples, computing system 200 utilizes temperature data from the temperature sensing system in accordance with some examples of the disclosure to improve a PPG sensor. The absorption and/or return of light at different wavelengths can also be used to determine a characteristic of the user (e.g., oxygen saturation, heart rate) and/or about the contact condition between the light emitter(s) 204/light detector(s) 206 and the user's skin. Measured raw data from the light emitter(s) 204, light detector(s) 206, and sensing circuitry 208 can be transferred to host processor 210, and host processor 210 can perform the signal processing described herein to estimate a characteristic (e.g., oxygen saturation, heart rate, etc.) of the user of the example electronic device from the physiological signals. Host processor 210 and/or optical sensor(s) controller 212 can operate light emitter(s) 204, light detector(s) 206 and/or sensing circuitry 208 to measure data from the optical sensor. In some examples, optical sensor controller(s) 212 can include timing generation for light emitters 204, light detectors 206 and/or signal processor 214 to sample, filter and/or convert (from analog to digital) signals measured from light at different wavelengths. Optical sensor(s) controller 212 can process the data in signal processor 214 and report outputs (e.g., PPG signal, relative modulation ratio, perfusion index, heart rate, on-wrist/off-wrist state, etc.) to the host processor 210. Signal processor 214 can be a digital signal processing circuit such as a digital signal processor (DSP). The analog data measured by the optical sensor(s) 211 can be converted into digital data by an analog to digital converter (ADC), and the digital data from the physiological signals can be stored for processing in a buffer (e.g., a FIFO) or other volatile or non-volatile memory (not shown) in optical sensor(s) controller 212. In some examples, some light emitters and/or light detectors can be activated, while other light emitters and/or light detectors can be deactivated (by power management circuitry 209) to conserve power, for example, or for time-multiplexing (e.g., to avoid interference between channels). In some examples, host processor 210 and/or optical sensor(s) controller 212 can store the raw data and/or processed information in memory (e.g., ROM or RAM) for historical tracking or for future diagnostic purposes.

In the illustrated example, computing system 200 includes one or more motion and/or orientation sensor(s) 230. The one or more motion and/or orientation sensor(s) 230 optionally includes an accelerometer (e.g., a multi-channel accelerometer (e.g., a 3-axis accelerometer), a gyroscope, and/or an inertia-measurement unit (IMU)).

In the illustrated example, computing system 200 includes a touch and display controller 216 operatively coupled to host processor 210 and to touch screen 220. Touch screen 220 can be configured to display visual output in a graphical user interface (GUI), for example. The visual output can include text, graphics, video, and any combination thereof. In some examples, the visual output can include a text or graphical representation of the physiological signal (e.g., a PPG waveform) or a characteristic of the physiological signal (e.g., oxygen saturation, heart rate, temperature, etc.) Touch screen can be any type of display including a liquid crystal display (LCD), a light emitting polymer display (LPD), an electroluminescent display (ELD), a field emission display (FED), a light emitting diode (LED) display, an organic light emitting diode (OLED) display, or the like. Host processor 210 can send raw display data to touch and display controller 216, and touch and display controller 216 can send signals to touch screen 220. Data can include voltage levels for a plurality of display pixels in touch screen 220 to project an image. In some examples, host processor 210 can be configured to process the raw data and send the signals to touch screen 220 directly. Touch and display controller 216 can also detect and track touches or near touches (and any movement or release of the touch) on touch screen 220. For example, touch processor 218 can process data representative of touch or near touches on touch screen 220 (e.g., location and magnitude) and identify touch or proximity gestures (e.g., tap, double tap, swipe, pinch, reverse-pinch, etc.). Host processor 210 can convert the detected touch input/gestures into interaction with graphical objects, such as one or more user-interface objects, displayed on touch screen 220 or perform other functions (e.g., to initiate a wake of the device or power on one or more components).

In some examples, touch and display controller 216 can be configured to send raw touch data to host processor 210, and host processor 210 can process the raw touch data. In some examples, touch and display controller 216 can process raw touch data via touch processor 218. The processed touch data (touch input) can be transferred from touch processor 218 to host processor 210 to perform the function corresponding to the touch input. In some examples, a separate touch sensor panel and display screen can be used, rather than a touch screen, with corresponding touch controller and display controller.

In some examples, the touch sensing of touch screen 220 can be provided by capacitive touch sensing circuitry (e.g., based on mutual capacitance and/or self-capacitance). For example, touch screen 220 can include touch electrodes arranged as a matrix of small, individual plates of conductive material or as drive lines and sense lines, or in another pattern. The electrodes can be formed from a transparent conductive medium such as Indium Tin Oxide (ITO) or Antimony Tin Oxide (ATO), although other partially or fully transparent and non-transparent materials (e.g., copper) can also be used. In some examples, the electrodes can be formed from other materials including conductive polymers, metal mesh, graphene, nanowires (e.g., silver nanowires) or nanotubes (e.g., carbon nanotubes). The electrodes can be configurable for mutual capacitance or self-capacitance sensing or a combination of mutual and self-capacitance sensing. For example, in one mode of operation, electrodes can be configured to sense mutual capacitance between electrodes; in a different mode of operation, electrodes can be configured to sense self-capacitance of electrodes. During self-capacitance operation, a touch electrode can be stimulated with an AC waveform, and the self-capacitance to ground of the touch electrode can be measured. As an object approaches the touch electrode, the self-capacitance to ground of the touch electrode can change (e.g., increase). This change in the self-capacitance of the touch electrode can be detected and measured by the touch sensing system to determine the positions of one or more objects when they touch, or come in proximity to without touching, the touch screen. During mutual capacitance operation, a first touch electrode can be stimulated with an AC waveform, and the mutual capacitance between the first touch electrode and a second touch electrode can be measured. As an object approaches the overlapping or adjacent region of the first and second touch electrodes, the mutual capacitance therebetween can change (e.g., decrease). This change in the mutual capacitance can be detected and measured by the touch sensing system to determine the positions of one or more objects when they touch, or come in proximity to without touching, the touch screen. In some examples, some of the electrodes can be configured to sense mutual capacitance therebetween and some of the electrodes can be configured to sense self-capacitance thereof.

The firmware can also be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this disclosure, a “non-transitory computer-readable storage medium” can be any medium (excluding signals) that can contain or store the program for use by or in connection with the instruction execution system, apparatus, or device. The computer-readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

In some examples, data from one or more components of computing system 200 (e.g., touch and display controller 216, optical sensor(s) 212, motion and/or orientation sensor(s)) are utilized along with temperature data from the temperature sensor(s) 250 according to some examples of the disclosure. In some examples, an electronic device includes more, fewer, or different components than computing system 200 and utilizes temperature data of a temperature sensing system according to some examples of the disclosure.

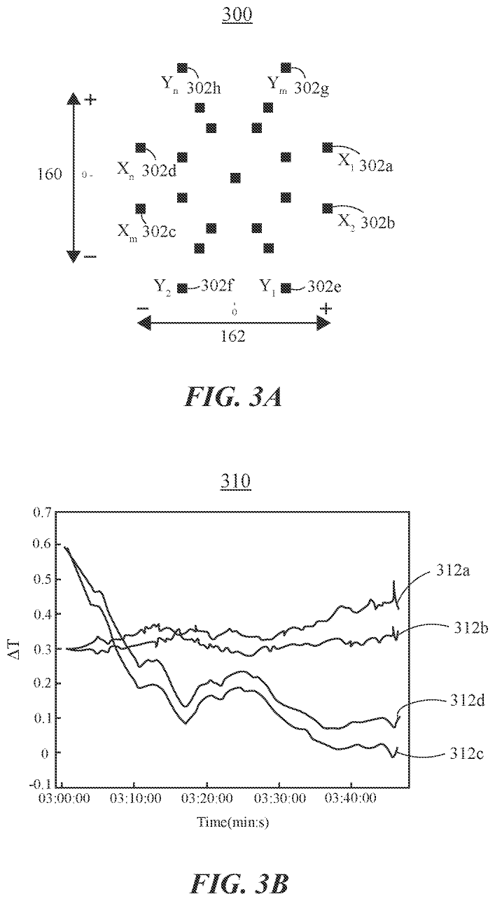

FIG. 3A illustrates an example spatial distribution 300 of temperature sensors (and of locations of temperature measurements) of electronic device 150 of FIG. 1 according to some examples of the disclosure. The temperature sensors can detect skin temperatures that correspond to various points along the surface of the skin of the user of the electronic device. For example, in FIG. 3A, the temperature sensors are located at various positions in a region defined by axis 160 and axis 162 (e.g., a y-axis and an x-axis), which optionally corresponds to coordinates projected on a plane closest to a back face of the electronic device (e.g., the face secured to the user while the user wears the electronic device). In the context of electronic device 150 of FIG. 1, FIG. 3A depicts temperature sensor X₁ 302a and temperature sensor X₂ 302b each optionally represent a temperature sensor that is nearest the side of electronic device 150 that includes the speaker 155 and optionally have the same position on axis 162. Likewise, in FIG. 3A, temperature sensor Xₘ 302c and temperature sensor Xₙ 302d each optionally represent a temperature sensor that is nearest the side of electronic device 150 that includes the digital crown 161 and optionally have the same position on axis 162. In FIG. 3A, temperature sensor Y₁ 302e and temperature sensor Y₂ 302f each optionally represent a temperature sensor that y have the same position on axis 160, with temperature sensor Y₁ 302e nearer than temperature sensor Y₂ 302f to the side of electronic device of FIG. 1 that includes speaker 155. In FIG. 3A, temperature sensor Yₘ 302g and temperature sensor Yₙ 302h each optionally represent a temperature sensor that optionally have the same position on axis 160, at a different position on axis 160 than the alignment of temperature sensor Y₁ and temperature sensor Y₂ on axis 160, with temperature sensor Yₘ 302g nearer than temperature sensor Yₙ 302h to the side of electronic device 150 of FIG. 1 that includes speaker 155.

FIG. 3A illustrates a distribution of twenty-one temperature sensors in electronic device 150 of FIG. 1. In some examples, more or fewer temperature sensors are included in the electronic device than in the illustrated example. In some examples, the distribution of temperature sensors is arranged symmetrically for the electronic device (e.g., mirrored relative to the line defined by x=0 or the line defined by y=0). In some examples, the distribution of temperature sensors is not arranged symmetrically to an axis of the electronic device. In some examples, an electronic device includes at least two temperature sensors configured to detect skin temperatures and performs the disclosed processes using temperature data from the at least two temperature sensors. In some examples, the at least two temperature sensors have similar or different distances from a respective portion of the user. In some examples, the at least two temperature sensors have similar or different positions along an axis perpendicular to the plane of axis 160 and axis 162 (e.g., different heights within the housing of the electronic device).

A temperature gradient (e.g., a thermal gradient) optionally exists on the portion 152 (e.g., on the skin surface of the left wrist in contact with a back face of the housing 151 of electronic device 150 that contacts the skin surface) of the user of electronic device 150 of FIG. 1 (e.g., optionally when the user is awake and/or asleep). Using temperature data from temperature sensors, a system, such as computing system 200, optionally determines spatial temperature gradients, which corresponds to differences in temperature between (at least) two locations (e.g., two locations of the portion 152 of the user) and/or temporal variations of the spatial temperature gradients, which correspond to differences in temperature between (at least) two locations (e.g., two locations of the portion 152 of the user) with respect to time, corresponding to the user. For example, the electronic device optionally determines a spatial temperature gradient

ΔT_{X-Y}(t)

corresponding to a temperature gradient at a time t using temperature sensors (e.g., of electronic device 150 having the temperature sensor distribution of FIG. 3A) located at various positions in the region defined by axis 160 and axis 162 (e.g., y-axis and x-axis). For example, data from each of the temperature sensors of FIG. 3A, in which each square dot optionally represents a temperature sensor at a particular location in the region, optionally is used to determine a spatial temperature gradient of the user corresponding to the temperature sensor at the particular location in the region. In another example, computing system 200 optionally determines temporal variations of spatial temperature gradient along the axis 162 and determines temporal variations of spatial temperature gradient along the axis 160 using the detected skin temperatures, such as shown in FIG. 3B.

FIG. 3B illustrates a graph 310 showing temporal variations of wrist (e.g., skin) spatial temperature gradients based on temperature data detected by temperature sensors of electronic device 150 of FIG. 1 according to some examples of the disclosure. In FIG. 3B, graph 310 shows lines of temporal variations of wrist spatial temperature gradients at temperature sensor X₁ 302a of FIG. 3A along axis 162 of FIG. 3A (e.g., line 312a) and at temperature sensor X₂ 302b of FIG. 3A along axis 160 of FIG. 3A (e.g., line 312b) over a time period in which a user wears the electronic device. In FIG. 3B, graph 310 also shows lines of temporal variations of wrist spatial temperature gradients at temperature sensor Y₁ 302e of FIG. 3A along axis 162 of FIG. 3A (e.g., line 312c) and at temperature sensor Y₂ 302f of FIG. 3A along axis 160 of FIG. 3A (e.g., line 312d) over a time period in which a user wears the electronic device.

In particular, in graph 310 of FIG. 3B, line 312a corresponds to Expression 1, in which

$$Δ {T}_{x 1} ( t ) = {X}_{1} ( t ) - {X}_{n} ( t )$$

where ΔTₓ₁(t) corresponds to temporal variations of wrist spatial temperature gradient along axis 162 of FIG. 3A, X₁(t) corresponds to temperature data as a function of time t detected at temperature sensor X₁ 302a of FIG. 3A, and Xₙ(t) corresponds to temperature data as a function of time t detected at temperature sensor Xₙ 302d of FIG. 3A. Line 312b of FIG. 3B corresponds to Expression 2, in which

$$Δ {T}_{x 2} ( t ) = {X}_{2} ( t ) - {X}_{m} ( t )$$

where ΔTₓ₂(t) corresponds to temporal variations of wrist spatial temperature gradient along axis 162 of FIG. 3A, X₂(t) corresponds to temperate data as a function of time t detected at temperature sensor X₂ 302b of FIG. 3A, and Xₘ (t) corresponds to temperature data as a function of time t detected at temperature sensor Xₘ 302c of FIG. 3A.

Also, line 312c of FIG. 3B corresponds to Expression 3, in which

$$Δ {T}_{y 1} ( t ) = {Y}_{1} ( t ) - {Y}_{m} ( t )$$

where ΔT_{y1}(t) corresponds to temporal variations of wrist spatial temperature gradient along axis 160 of FIG. 3A, Y₁ (t) corresponds to temperature data as a function of time t detected at temperature sensor Y₁ 302e of FIG. 3A, and Yₘ(t) corresponds to temperature data detected at temperature sensor Yₘ 302g of FIG. 3A as a function of time t. Further, line 312d of FIG. 3B corresponds to Expression 4, in which

$$Δ {T}_{y 2} ( t ) = {Y}_{2} ( t ) - {Y}_{n} ( t )$$

where ΔT_{y2}(t) corresponds to temporal variations of wrist spatial temperature gradient along axis 160 of FIG. 3A, Y₂(t) corresponds to temperature data as a function of time t detected at temperature sensor Y₂ 302f of FIG. 3A, and Yₙ(t) corresponds to temperature data detected at temperature sensor Yₙ 302h of FIG. 3A as a function of time t.

### Physiological State Detection

In some examples, an electronic device utilizes homogeneity estimation metrics (e.g., mean, average, range, Root Mean Square (RMS), standard deviation, or another estimation metric) applied to temperature data to determine a physiological state of the user (e.g., whether a user of the electronic device is awake, resting, or asleep). For example, in some cases, skin temperature homogeneity optionally increases (e.g., skin temperature gradients optionally decrease in value) during a resting state (e.g., a well-rested state) or sleep state of a user of the electronic device and decreases (e.g., skin temperature gradients optionally increase in value) when a person is awake and/or active. In this example, the electronic device optionally determines an amount of skin temperature homogeneity of a user using at least the temperature data detected by temperature sensors of the electronic device and then predicts a physiological state of the user, such as a resting, awake, active, resting and awake, or sleep state of the user of the electronic device.

In some examples, an electronic device detects temporal variations of one or more skin spatial temperature gradients. In some examples, an electronic device determines a Root Mean Square (RMS) estimation of the temporal variations of one or more skin spatial temperature gradients to determine a physiological state of the user of the electronic device.

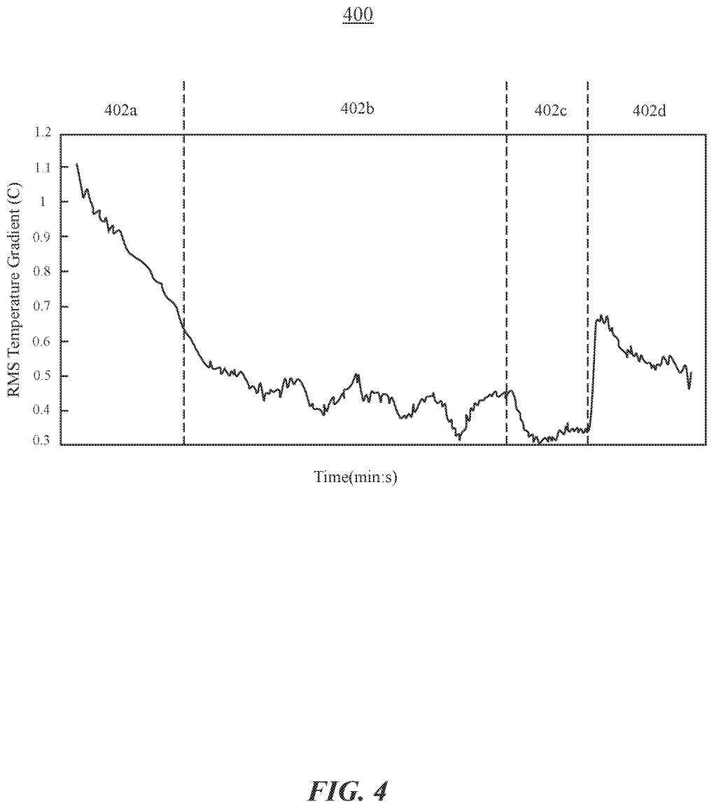

FIG. 4 illustrates a graph 400 showing a Root Mean Square (RMS) estimation of temporal variations in a skin spatial temperature gradient. In some examples, the RMS temperature gradient model is based on data collected by a single user of the electronic device, multiple users of the electronic device, person(s) who are not users of the electronic device, or any combination thereof.

As discussed above, skin temperature homogeneity generally decreases when a person is awake and/or active and increases when a person is well rested or asleep. The electronic device optionally determines skin temperature homogeneity of a user in order to determine a physiological status of the user. For example, in response to determining that the user of the electronic device has an RMS skin temperature homogeneity estimation within a first range (e.g., 0.5-1.2 degrees Celsius or another range) optionally over a predetermined period of time, such as the range of RMS skin temperature homogeneity in section 402a, the electronic device optionally determines that the user is beginning to rest. Additionally or alternatively, in response to determining that the user of the electronic device has an RMS skin temperature homogeneity estimation within a second range (e.g., 0.3-0.6 degrees Celsius or another range) optionally over a predetermined period of time, such as the range of RMS skin temperature homogeneity in section 402b, the electronic device optionally determines that the user is fully relaxed and is in a physiological transition to a sleeping state. Additionally or alternatively, in response to determining that the user of the electronic device has an RMS skin temperature homogeneity estimation within a third range (e.g., 0.1-0.5 degrees Celsius or another range) optionally over a predetermined period of time, such as the range of RMS skin temperature homogeneity in section 402c, the electronic device optionally determines that the user is asleep. Additionally, or alternatively, in response to determining that the user of the electronic device has an RMS skin temperature homogeneity estimation within a fourth range (e.g., 0.3-0.9 degrees Celsius or another range) optionally over a predetermined period of time, such as the range of RMS skin temperature homogeneity in section 402d, the electronic device optionally determines that the user has awaken from sleep. As such, temperature gradient data of a user of the electronic device can be processed within a homogeneity estimation metric to determine a physiological state of the user of the electronic device. Further, the electronic device optionally uses dynamic thresholding based on statistical parameters such as mean, average, range, and the like, to determine the physiological state (e.g., physical status) of the user of the electronic device. In some examples, a first order model, such as RMS temperature, or a higher order model is used in the determination of the physiological state of the user. In some examples, an electronic device determines a rate of change of RMS temperature homogeneity estimation (e.g., RMS skin temperature homogeneity) over a predetermined period of time and utilizes such data to determine whether the user is active, resting, beginning to rest, beginning to sleep, or in another physiological state. For example, as shown in section 402a of FIG. 4, the rate of change of RMS temperature homogeneity.

In some examples, the electronic device determines whether the user of the electronic device is awake (e.g., in a vasoconstriction state) or asleep (e.g., in a vasodilation state) by determining a homogeneity estimation of temporal variations of skin spatial temperature gradient for the user over a particular time or at a particular time (or by determining one or more temperature gradients of the user over the particular time or at the particular time) and comparing the determined homogeneity estimation of temporal variations of skin spatial temperature gradient for the user or the determined one or more temperature gradients to a dataset corresponding to temperature gradients of different users over time and configured to predict a physiological state of the user based on the comparison. In some examples, the dataset is stored in a remote server in communication with the electronic device and the electronic device transmits the determined homogeneity estimation of temporal variations of skin spatial temperature gradient for the user over the particular time and/or the one or more temperature gradients of the user, and then receives, from the remote server, a prediction of a physiological state of the user. In some examples, the dataset is stored in the electronic device, such as in the program storage 202 of computing system 200 of FIG. 2. In some examples, a machine learning process is used to train and/or increase an accuracy of the determined physiological state of the user, such as by training a system with temperature data corresponding to different persons and detecting physiological states of the persons based on the temperature data. In some examples, an algorithm that utilizes the temperature data, optionally in addition to other types of data, is used to perform the determination of the physiological state of the user.

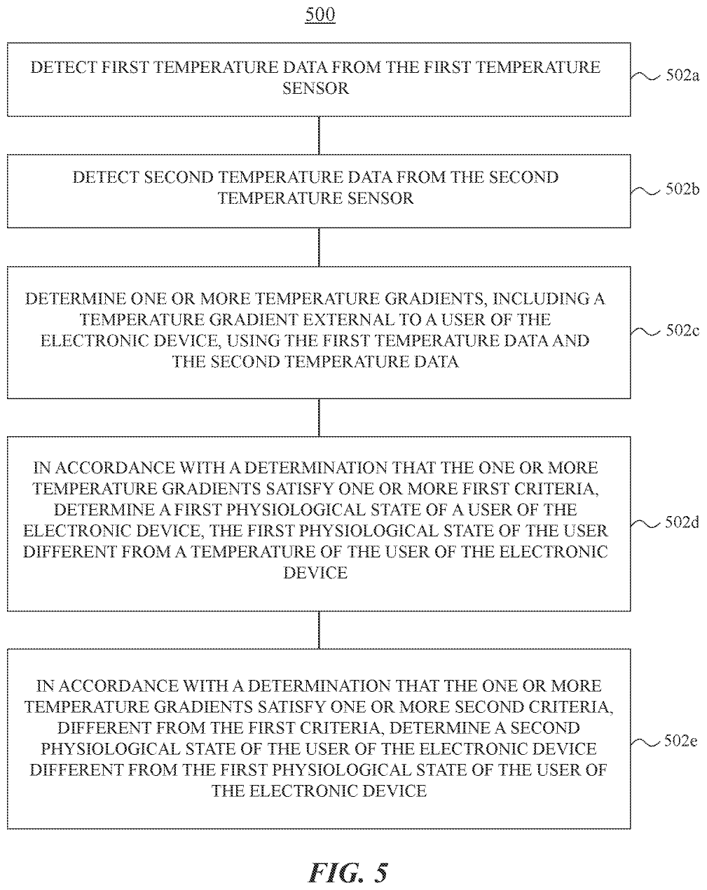

FIG. 5 illustrates a flowchart of a method 500 for determining one or more characteristics of a user using temperature gradients according to some examples of the disclosure. Method 500 is optionally performed at an electronic device that includes a first temperature sensor and a second temperature sensor different from the first temperature sensor, such as computing system 200. Method 500 includes detecting (502a) first temperature data from the first temperature sensor, such as temperature sensor X₁ 302a of FIG. 3A, detecting (502b) second temperature data from the second temperature sensor, such as temperature sensor Xₙ 302d of FIG. 3A, and determining (502c) one or more temperature gradients (e.g., temporal variations in temperature gradients), including a temperature gradient external to a user of the electronic device, using the first temperature data from the first temperature sensor and the second temperature data from the second temperature sensor, such as ΔTₓ₁(t) in Expression 1. Method 500 also includes in accordance with a determination that the one or more temperature gradients satisfy one or more first criteria, determining (502d) a first physiological state of a user of the electronic device, the first physiological state of the user different from a temperature of the user of the electronic device, such as an awake, active, or another type of state, such as discussed with reference to FIG. 4. Method 500 also includes in accordance with a determination that the one or more temperature gradients satisfy one or more second criteria, different from the first criteria, determining (502e) a second physiological state of the user of the electronic device different from the first physiological state of the user of the electronic device, such as resting, sleeping, or another type of state, such as discussed with reference to FIG. 4.

In some examples, the one or more temperature gradients include a plurality of temperature gradients, such as temporal variations of a plurality of wrist spatial temperature gradients discussed with reference to Expressions 1-4 and/or FIG. 4. In some examples, the one or more first criteria include a criterion that is satisfied when a value of a statistical parameter based on the of the plurality of temperature gradients is above a threshold, such as when a thermal homogeneity metric corresponding to an overall skin gradient is above a threshold value, such as generally described with reference to FIG. 4.

In some examples, the one or more second criteria include a criterion that is satisfied when the value of the statistical parameter based on of the plurality of temperature gradients is below the threshold, such as when a thermal homogeneity metric corresponding to an overall skin gradient is below a threshold value, such as generally described with reference to FIG. 4.

In some examples, the first physiological state of the user of the electronic device is a sleep state of the user of the electronic device, such as generally described with reference to FIG. 4.

In some examples, the second physiological state of the user of the electronic device is an awake state of the user of the electronic device, such as generally described with reference to FIG. 4.

In some examples, the electronic device includes a third temperature sensor, such as an electronic device including the distribution of temperature sensors illustrated in FIG. 3A. In some examples, method 500 includes detecting third temperature data from the third temperature sensor, and determining the one more temperature gradients using the first temperature data, the second temperature data, and the third temperature data, such as by calculating spatial temperature gradients and/or temporal variations in spatial temperature gradients relative to a location of the first temperature sensor using the second temperature data and the third temperature data (e.g., subtracting the second temperature data from the first temperature data and subtracting the third temperature data from the first temperature data to determine a spatial temperature gradient relative to the location of the first temperature sensor and/or temporal variations in spatial temperature gradient relative to the location of the first temperature sensor), such as according to any of Expression 1-4.

In some examples, an electronic device includes a first temperature sensor, a second temperature sensor, and processing circuitry configured to perform method 500 and/or any other operation(s) described in this disclosure.

In some examples, one or more non-transitory computer readable storage medium stores one or more programs, the one or more programs comprising instructions, which when executed by processing circuitry of an electronic device, cause the electronic device to perform method 500 and/or any operation(s) described in this disclosure.

### Orientation Detection

In some examples, the electronic device processes temperature gradient data, such as spatial temperature gradient data, to determine an orientation of the electronic device (e.g., a watch orientation). For instance, electronic device 150 of FIG. 1 optionally measures an intrinsic spatial temperature profile of human wrist tissue (e.g., an intrinsic temperature gradient) to detect the watch orientation by determining a directionality of a temperature gradient along axis 162. As such, the electronic device optionally uses a directionality of a spatial temperature gradient to determine an orientation of the electronic device (e.g., relative to the wrist). In some examples, a device different from the electronic device processes the temperature data that the electronic device collects and transmits to the electronic device a determined orientation of the electronic device.

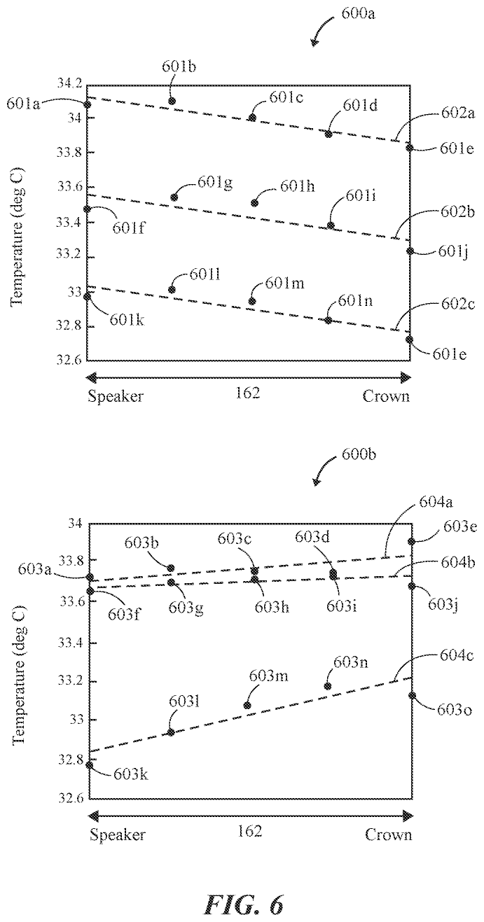

FIG. 6 illustrates graphs 600a and 600b of spatial temperature distribution measured by temperature sensors of electronic device 150 of FIG. 1 located at different positions along axis 162 for a set of users. Graph 600a corresponds to an orientation of the electronic device 150 of FIG. 1 in which the digital crown 161 of electronic device 150 faces the proximal side of the user of the electronic device while electronic device 150 is worn on a left wrist of the user (e.g., a first orientation), which is the illustrated configuration of electronic device 150 in FIG. 1. Electronic device 150 optionally measures temperature data corresponding to different positions along axis 162 using temperatures sensors distributed in the electronic device along axis 162, such as shown in FIG. 3A, such as X₁ 302a and Xₙ 302d of FIG. 3A optionally in addition to temperature sensors in between X₁ 302a and Xₙ 302d of FIG. 3A. Detected temperatures 601a through 601c correspond to temperature data corresponding to different respective positions along axis 162 using temperatures sensors. Detected temperatures 601f through 601j correspond to temperature data corresponding to the different respective positions along axis 162 using temperatures sensors distributed in the electronic device along axis 162, such as shown in FIG. 3A, while the electronic device is worn by a second user in the first orientation. Detected temperatures 601k through 601o correspond to temperature data corresponding to the different respective positions along axis 162 using temperatures sensors distributed in the electronic device along axis 162, such as shown in FIG. 3A, while the electronic device is worn by a third user in the first orientation.

In graph 600a, the detected temperatures (e.g., 601a through 601e corresponding to the first user, 601f through 601j corresponding to the second user, and 601k through 601o corresponding to the third user, optionally at a particular time or an aggregate of temperatures detected at the specific points over a period of time) generally decrease in value along the axis 162 toward the digital crown 161 that faces the proximal side of the user, as seen by data fit lines 602a through 602c, whereby data fit line 602 is a fit of detected temperatures 601a through 601e, data fit line 602b is a fit of detected temperatures 601f through 601j, and data fit line 602c is a fit of detected temperatures 601k through 601o. As such, in graph 600a, a negative spatial temperature gradient characterizes the overall spatial temperature distribution along axis 162 toward the digital crown 161, as seen by the data fit lines 602a through 602c. The electronic device optionally stores data that corresponds the negative spatial temperature gradient to the orientation of the electronic device on the wrist of the user being the digital crown 161 faces the proximal side of the user. As such, in response to detecting that a user dons electronic device 150 of FIG. 1, electronic device 150 of FIG. 1 optionally initiates detecting temperature data via at least two temperature sensors, optionally corresponding to at least two locations along axis 162 of FIG. 1, and in response to a determination that the overall spatial temperature gradient along axis 162 of FIG. 1 toward the digital crown 161 of FIG. 1 is negative in value, the electronic device optionally determines that the electronic device is oriented on the portion of the user with the digital crown 161 of FIG. 1 facing the proximal side of the user. Accordingly, in some examples, the electronic device determines an orientation of the electronic device using spatial temperature gradients corresponding to skin of the user (optionally at a particular time).

Graph 600b corresponds to the electronic device 150 of FIG. 1 in an orientation different than the illustrated orientation of electronic device 150 of FIG. 1. In particular, in the second orientation of electronic device 150 represented in graph 600b, the digital crown 161 of the electronic device 150 faces the distal side of the user of the electronic device while the electronic device is worn on a left wrist of the user (whereas in the first orientation shown in FIG. 1 the digital crown 161 faces the proximal side of the user). Electronic device 150 optionally measures temperature data corresponding to different positions along axis 162 using temperatures sensors distributed in the electronic device along axis 162, such as shown in FIG. 3A such as X₁ 302a and Xₙ 302d of FIG. 3A optionally in addition to temperature sensors in between X₁ 302a and Xₙ 302d of FIG. 3A. Detected temperatures 603a through 603e correspond to temperature data corresponding to the different respective positions along axis 162 using temperatures sensors distributed in the electronic device along axis 162, such as shown in FIG. 3A, while the electronic device is worn by a first user in the second orientation. Detected temperatures 603f through 603j correspond to temperature data corresponding to the different respective positions along axis 162 using temperatures sensors distributed in the electronic device along axis 162, such as shown in FIG. 3A, while the electronic device is worn by a second user in the second orientation. Detected temperatures 603k through 603o correspond to temperature data corresponding to the different respective positions along axis 162 using temperatures sensors distributed in the electronic device along axis 162, such as shown in FIG. 3A, while the electronic device is worn by a third user in the second orientation.

As shown in graph 600b, the detected temperatures (e.g., 603a through 603c corresponding to the first user, 603f through 603j corresponding to the second user, and 603k through 603o corresponding to the third user, optionally at a particular time or an aggregate of temperatures detected at the specific points over a period of time) generally increase in value along the axis 162 of FIG. 1 when the digital crown 161 faces the distal side of the user, as seen by the data fit lines 604a through 604c, as seen by data fit lines 604a through 604c, whereby data fit line 604a is a fit of detected temperatures 603a through 603e, data fit line 604b is a fit of detected temperatures 603f through 603j, and data fit line 604c is a fit of detected temperatures 603k through 603o. As such, while electronic device 150 of FIG. 1 is in the orientation of digital crown 161 of FIG. 1 facing the distal side of the user of the electronic device while the electronic device is worn on the left wrist of the user, a positive spatial temperature gradient characterizes the overall spatial temperature distribution along axis 162 of FIG. 1 toward the digital crown 161 of FIG. 1. The electronic device optionally stores data that corresponds a positive spatial temperature gradient to the orientation of the electronic device on the wrist of the user being the digital crown 161 of FIG. 1 faces the distal side of the user. As such, in response to detecting that a user dons the electronic device, the electronic device optionally initiates detecting temperature data via at least two temperature sensors corresponding to at least two locations along axis 162, and in response to a determination that the overall spatial temperature gradient along axis 162 toward the digital crown 161 is positive in value, the electronic device optionally determines that the electronic device is oriented on the portion of the user such that the digital crown 161 of FIG. 1 faces the distal side of the user. Accordingly, in some examples, the electronic device determines an orientation of the electronic device using spatial temperature gradients corresponding to skin of the user (optionally at a particular time).

In some examples, the electronic device includes a temperature sensor for measuring an ambient temperature and uses temperature data from the temperature sensor for measuring the ambient temperature to determine how to utilize the temperature gradient data corresponding to the skin of the user for determining orientation. For example, a cold ambient temperature optionally causes a proximal side of user (e.g., relative to a user's wrist) to be warmer than a distal side of user (e.g., relative to the user's wrist), which is optionally not typically the case in room temperature or a range of temperatures (e.g., 18-25 degrees Celsius). As such the electronic device optionally uses temperature data from the temperature sensor for measuring the ambient temperature to determine how to utilize the temperature gradient data corresponding to the skin of the user. For example, in response to a determination that the overall spatial temperature gradient along axis 162 of FIG. 1 toward the digital crown 161 is positive in value and that the temperature data from the temperature sensor for measuring the ambient temperature is within a first temperature range, the electronic device optionally determines that the electronic device is oriented on the portion of the user such that the digital crown 161 faces the distal side of the user. Further, in response to a determination that the overall spatial temperature gradient along axis 162 toward the digital crown 161 is negative in value and that the temperature data from the temperature sensor for measuring the ambient temperature is outside the first temperature range (e.g., colder than the first temperature range), the electronic device optionally determines that the electronic device is oriented on the portion of the user such that the digital crown faces the proximal side of the user. As such, the electronic device optionally utilizes temperature data from the temperature sensors that measures ambient temperature to determine how to utilize (e.g., interpret) the temperature gradient data corresponding to the skin of the user for determining orientation.

In some examples, the electronic device orients a graphical user interface of the electronic device based on a determined orientation of the electronic device. For instance, in some examples, in response to detecting a user donning the electronic device, the electronic device initiates temperature sensing in order to detect an orientation of the electronic device on the user. Then, in this instance, the electronic device optionally processes (or transmits the temperature sensing data to a remote server) the temperature sensing data in order to determine the orientation of the electronic device on the user. Also, in this instance, in response to determining that the electronic device has a first orientation (e.g., the digital crown 161 of FIG. 1 faces the proximal section of the user), the electronic device optionally displays a graphical user interface with an orientation that is based on the first orientation of the electronic device. Likewise, in this instance, in response to determining that the electronic device has a second orientation (e.g., the digital crown 161 of FIG. 1 faces the distal section of the user), the electronic device optionally displays a graphical user interface with an orientation that is based on the second orientation of the electronic device.

In some examples, the electronic device determines a portion of the user on which the user wears the electronic device, optionally in addition to determining an orientation of the electronic device on the portion of the user. For instance, the electronic device optionally utilizes data from other sensors, such as inertial measurement unit (IMU), an accelerometer, and/or another type of sensor, in addition to temperature data from temperature sensors, to determine the portion of the user (e.g., left wrist, right wrist, or another portion of the user) on which the user wears the electronic device. For example, the electronic device is optionally in a display-off state while a wrist of the user of the electronic device is not in a line of sight of the user. In this example, the user may move the user's wrist to be in the line of sight of the user; the movement is optionally detected by the IMU, the accelerometer, and/or another type of sensor. Continuing with this example, in response to detecting the movement of the user's wrist toward the line of sight of the user, and optionally in response to detecting an orientation of the electronic device on the user (e.g., digital crown 161 facing the proximal side or distal side of the user), the electronic device optionally corresponds such data to determine which wrist the user wears the electronic device.

In some examples, the electronic device identifies the orientation of the electronic device by using the temperature gradient along one axis, such as axis 162 of FIG. 1 with or without using the temperature gradient along another axis, such as axis 160 of FIG. 1.

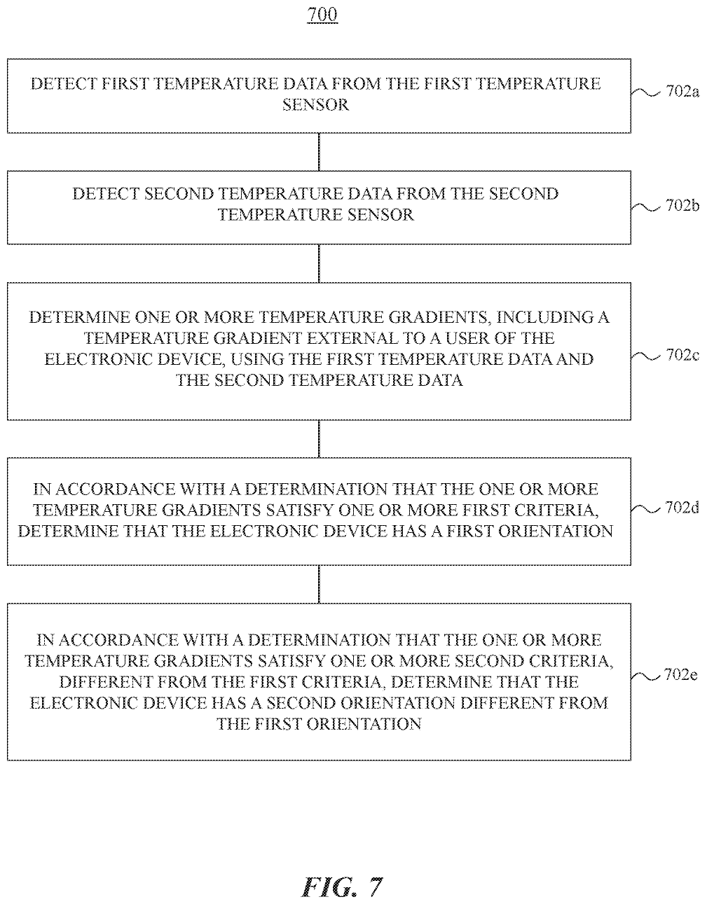

FIG. 7 illustrates a flowchart of a method 700 for determining one or more orientations using temperature gradients according to some examples of the disclosure. Method 700 is optionally performed at an electronic device that includes a first temperature sensor and a second temperature sensor different from the first temperature sensor. The method includes detecting (702a) first temperature data from the first temperature sensor, such as temperature sensor X₁ 302a of FIG. 3A, detecting (702b) second temperature data from the second temperature sensor, such as temperature sensor Xₙ 302d of FIG. 3A, and determining (702c) one or more temperature gradients, including a temperature gradient external to a user of the electronic device, using the first temperature data and the second temperature data, such as described with reference to FIG. 6. The method also includes in accordance with a determination that the one or more temperature gradients satisfy one or more first criteria, such as the spatial temperature gradient being a positive value, determining (702d) that the electronic device has a first orientation, such as a first side of the electronic device facing the proximal side of a user, such as described with reference to FIG. 6, and in accordance with a determination that the one or more temperature gradients satisfy one or more second criteria, different from the first criteria, such as the spatial temperature gradient being a negative value, determining (702c) that the electronic device has a second orientation different from the first orientation of the electronic device, such as the first side of the electronic device facing the distal side of the user, such as described with reference to FIG. 6.

In some examples, determining the one or more temperature gradients using the first temperature data and the second temperature data includes determining a first set of the one or more temperature gradients along a first axis in the electronic device, such as first set of temporal temperature gradients along the axis 162 such as described with reference to FIG. 6.

In some examples, the first set of the one or more temperature gradients are a function of time, such as ΔTₓ₁(t) of Expression 1 and ΔTₓ₂(t) of Expression 2.

In some examples, determining the one or more temperature gradients using the first temperature data and the second temperature data includes determining a second set of the one more temperature gradients, different from the first set of the one or more temperature gradients, along a second axis in the electronic device different from the first axis in the electronic device, such as spatial temperature gradient data between temperature sensor Y₂ 302f of FIG. 3A and temperature sensor Yₙ 302h of FIG. 3A.

In some examples, the electronic device is worn on a portion of the user (e.g., a wrist, a head, a bicep, or another portion of a user), and the first orientation of the electronic device is relative to the portion of the user, such as the first orientation of the electronic device being a first side of the electronic device facing the proximal side of the user, such as digital crown 161 of FIG. 1 facing the proximal side of the user, as shown in FIG. 1.

In some examples, the second orientation of the electronic device is relative to the portion of the user, such as the first orientation of the electronic device being a first side of the electronic device facing the distal side of the user, such as digital crown 161 of FIG. 1 facing the distal side of the user.

In some examples, the electronic device is worn on a portion of the user, and determining the first orientation of the electronic device includes determining the portion of the user based on at least the one or more temperature gradients, such as determining which limb (e.g., right arm, right wrist, left leg, or another limb) or other portion of the user the user wears the electronic device.

In some examples, the first temperature sensor acquires the first temperature data at a first location and the second temperature sensor acquires the second temperature data at a second location, such as discussed with reference to FIG. 6. In some examples, the one or more first criteria include a criterion that is satisfied when a set of temperature gradients of the one or more determined temperatures gradients in a direction corresponding to from the first location to the second location has a positive value, such as shown in and described with reference to graph 600b of FIG. 6. In some examples, the one or more second criteria include a criterion that is satisfied when a set of temperature gradients in the direction corresponding to from the first location to the second location has a negative value, such as shown in and described with reference to graph 600a of FIG. 6.

In some examples, method 700 is performed while the electronic device is worn on a wrist (e.g., a left wrist or a right wrist) of a user of the electronic device. For example, the portion 152 of the user is a wrist of the user, and as such, the electronic device 150 of FIG. 1 is worn on the left wrist of the user.

In some examples, the first temperature sensor and the second temperature are horizontally aligned in the electronic device. For example, temperature sensors of the spatial distribution 300 of FIG. 3A optionally are on the plane of axis 160 and 162.

In some examples, the first temperature sensor and the second temperature are not horizontally aligned in the electronic device. For example, one or more temperature sensors of the spatial distribution 300 of FIG. 3A optionally are not on the region defined by axis 160 and axis 162 and/or the electronic device optionally includes one or more additional temperature sensors that are closer to a front face of the electronic device and/or to various positions in the electronic device that are optionally not on the region defined by axis 160 and axis 162.

In some examples, the electronic device includes a third temperature sensor, such as an electronic device including the distribution of temperature sensors illustrated in FIG. 3A. In some examples, method 700 includes detecting third temperature data from the third temperature sensor, and determining the one more temperature gradients using the first temperature data, the second temperature data, and the third temperature data, such as by calculating spatial temperature gradients and/or temporal variations in spatial temperature gradients relative to a location of the first temperature sensor using the second temperature data and the third temperature data (e.g., subtracting the second temperature data from the first temperature data and subtracting the third temperature data from the first temperature data to determine a spatial temperature gradient relative to the location of the first temperature sensor and/or temporal variations in spatial temperature gradient relative to the location of the first temperature sensor).

In some examples, method 700 includes detecting third temperature data from a third temperature sensor configured to measure an ambient temperature. In some examples, method 700 includes in accordance with a determination that the third temperature data satisfies one or more third criteria, such as the third temperature data being within a first range of temperatures, and the one or more temperature gradients satisfy the one or more first criteria, determining the first orientation of the electronic device. In some examples, the method includes in accordance with a determination that the third temperature data does not satisfy the one or more third criteria, such as the third temperature data being outside the first range of temperatures (e.g., colder than the first temperature range), and the one or more temperature gradients satisfy the one or more first criteria, determining the second orientation of the electronic device, such as discussed above in the disclosure. For example, in cold temperatures, the electronic device optionally uses the ambient temperature to increase an accuracy of prediction of a determined orientation of device.

In some examples, an electronic device includes a first temperature sensor, a second temperature sensor, and processing circuitry configured to perform any of method 700, including the any of the additional or alternative examples of method 700 described above.

In some examples, one or more non-transitory computer readable storage media stores one or more programs, the one or more programs comprising instructions, which when executed by processing circuitry of an electronic device, cause the electronic device to perform any of method 700, including any of the additional or alternative examples of the method 700 described above.

### FURTHER EXAMPLES

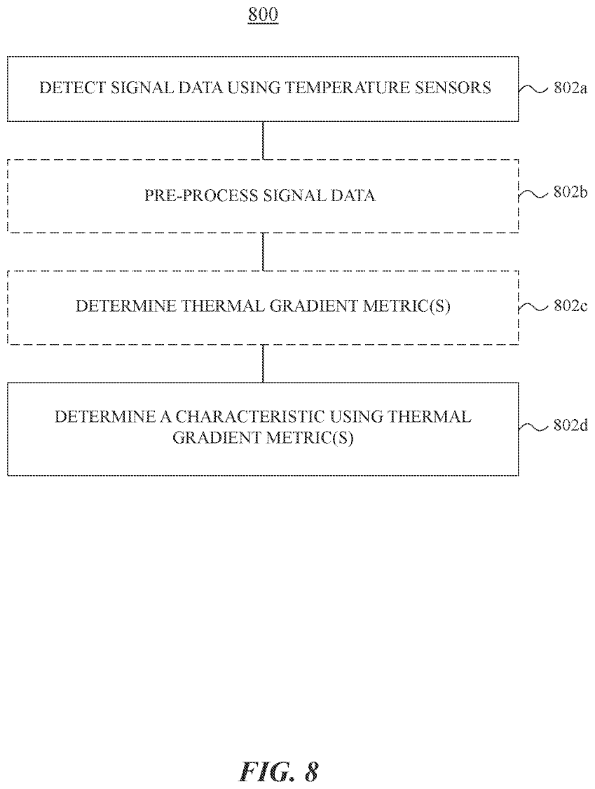

FIG. 8 illustrates a flowchart of a method 800 for determining one or more characteristics using temperature gradients according to some examples of the disclosure. Method 800 is optionally performed at an electronic device that includes a first temperature sensor and a second temperature sensor different from the first temperature sensor, such as computing system 200 of FIG. 2. Method 800 includes detecting temperature data using temperature sensors (802a), such as detecting signals of corresponding to temporal variation of wrist skin spatial temperature using distributed temperature sensors inside the electronic device. Method 800 optionally includes pre-processing (802b) the detected temperature data, such as by performing data clean up and/or filtering. Method 800 optionally includes determining (802c) temperature gradient metrics, such as by applying an algorithm to temperature data to generate temperature gradient metrics in both temporal and spatial domain. Method 800 optionally includes determining (802d) a characteristic using the temperature gradient metrics, such as a physiological state of a user, a portion of the user on which the user wears an electronic device, an orientation of the electronic device on the user, and/or skin thermal properties of the user. Additionally or alternatively, 802d of method 800 includes refining or improving an optical channel finer calibration, and/or for improving a photoplethysmogram sensor using the thermal gradient metrics.

In some examples, one or more of the methods 500, 700, and 800 are combined and/or modified with one or more steps of any of methods 500, 700, and/or 800, including any of the additional or alternative examples of the methods 500, 700, and/or 800 described above.

It is understood that the present disclosure refers to a side of an electronic device facing a “proximal side” or a “distal side” of a user, primarily in the context of a wrist-worn device to respectively refer to “elbow-side” and “hand-side” of the wrist, is nonlimiting. Alternatively, the disclosure refers to a side of the electronic device being oriented towards or away from a user or a portion of the user. More generally, temperature gradients are used herein to determine an orientation of an electronic device relative to a user or a portion of the user. The correspondence between the temperature gradient and the orientation relative to the portion of the user depends on the placement of the electronic device (e.g., how contact is made between the body of the user and the wearable device) and its associated physiology. Additionally, although often described as a left side and a right side of the electronic device (e.g., from the perspective of the top down view of electronic device in FIG. 1), the orientation of the electronic device relative to the body is not so limited. In some examples, the electronic device has a left side, right side, back face, front face, and/or another reference point, and determining an orientation of the electronic device includes determining how a particular side (e.g., the left side, right side, back face, front face, and/or the other reference point) of the electronic device is oriented relative to the user and/or relative to a specific portion of the user (e.g., distal portion, proximal portion, top portion, bottom portion, torso portion, head portion, facing the user, not facing the user, front portion, back portion, or another portion of the user). In some examples, the methods 500, 700, and/or 800, including any of the additional or alternative examples of the methods 500, 700, and/or 800 described above, additionally or alternatively include the features discussed above.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. An electronic device, comprising:
a first temperature sensor;
a second temperature sensor; and
processing circuitry configured to:
detect first temperature data from the first temperature sensor;
detect second temperature data from the second temperature sensor;
determine one or more temperature gradients, including a temperature gradient external to a user of the electronic device, using the first temperature data and the second temperature data;
in accordance with a determination that the one or more temperature gradients satisfy one or more first criteria, determine that the electronic device has a first orientation; and
in accordance with a determination that the one or more temperature gradients satisfy one or more second criteria, different from the first criteria, determine that the electronic device has a second orientation different from the first orientation of the electronic device.

2. The electronic device of claim 1, wherein:
determining the one or more temperature gradients using the first temperature data and the second temperature data includes determining a first set of the one or more temperature gradients along a first axis in the electronic device.

3. The electronic device of claim 2, wherein:
the first set of the one or more temperature gradients are a function of time.

4. The electronic device of claim 2, wherein:
determining the one or more temperature gradients using the first temperature data and the second temperature data includes determining a second set of the one more temperature gradients, different from the first set of the one or more temperature gradients, along a second axis in the electronic device different from the first axis in the electronic device.

5. The electronic device of claim 1, wherein:
the electronic device is worn on a portion of the user, and
the first orientation of the electronic device is relative to the portion of the user.

6. The electronic device of claim 5, wherein:
the second orientation of the electronic device is relative to the portion of the user.

7. The electronic device of claim 1, wherein:
the electronic device is worn on a portion of the user, and
determining the first orientation of the electronic device includes determining the portion of the user based on at least the one or more temperature gradients.

8. The electronic device of claim 1, wherein:
the first temperature sensor acquires the first temperature data at a first location,
the second temperature sensor acquires the second temperature data at a second location,
the one or more first criteria include a criterion that is satisfied when a set of temperature gradients of the one or more determined temperature gradients in a direction corresponding to from the first location to the second location has a positive value, and
the one or more second criteria include a criterion that is satisfied when a set of temperature gradients in the direction corresponding to from the first location to the second location has a negative value.

9. The electronic device of claim 1 performed while the electronic device is worn on a wrist of a user of the electronic device.

10. The electronic device of claim 1, wherein the first temperature sensor and the second temperature are horizontally aligned in the electronic device.

11. The electronic device of claim 1, wherein the first temperature sensor and the second temperature are not horizontally aligned in the electronic device.

12. The electronic device of claim 1, wherein:
the electronic device includes a third temperature sensor, and
the processing circuitry is further configured to:
detect third temperature data from the third temperature sensor; and
determine the one more temperature gradients using:
the first temperature data,
the second temperature data; and
the third temperature data.

13. The electronic device of claim 1, wherein the processing circuitry is further configured to:
detect third temperature data from a third temperature sensor configured to measure an ambient temperature; and
in accordance with a determination that:
the third temperature data satisfies one or more third criteria, and
the one or more temperature gradients satisfy the one or more first criteria,
determine the first orientation of the electronic device, and
in accordance with a determination that:
the third temperature data does not satisfy the one or more third criteria, and
the one or more temperature gradients satisfy one or more first criteria,
determine the second orientation of the electronic device.

14. A method comprising:
at an electronic device, including a first temperature sensor and a second temperature sensor different from the first temperature sensor:
detecting first temperature data from the first temperature sensor;
detecting second temperature data from the second temperature sensor;
determining one or more temperature gradients, including a temperature gradient external to a user of the electronic device, using the first temperature data and the second temperature data;
in accordance with a determination that the one or more temperature gradients satisfy one or more first criteria, determining that the electronic device has a first orientation; and
in accordance with a determination that the one or more temperature gradients satisfy one or more second criteria, different from the first criteria, determining that the electronic device has a second orientation different from the first orientation of the electronic device.

15. The method of claim 14, wherein:
determining the one or more temperature gradients using the first temperature data and the second temperature data includes determining a first set of the one or more temperature gradients along a first axis in the electronic device.

16. The method of claim 15, wherein:
determining the one or more temperature gradients using the first temperature data and the second temperature data includes determining a second set of the one more temperature gradients, different from the first set of the one or more temperature gradients, along a second axis in the electronic device different from the first axis in the electronic device.

17. The method of claim 14, wherein:
the electronic device is worn on a portion of the user, and
the first orientation of the electronic device is relative to the portion of the user.

18. The method of claim 14, wherein:
the first temperature sensor acquires the first temperature data at a first location,
the second temperature sensor acquires the second temperature data at a second location,
the one or more first criteria include a criterion that is satisfied when a set of temperature gradients of the one or more determined temperature gradients in a direction corresponding to from the first location to the second location has a positive value, and
the one or more second criteria include a criterion that is satisfied when a set of temperature gradients in the direction corresponding to from the first location to the second location has a negative value.

19. A non-transitory computer readable storage medium storing one or more programs, the one or more programs comprising instructions, which when executed by processing circuitry of an electronic device including a first temperature sensor and a second temperature sensor, cause the electronic device to:
detect first temperature data from the first temperature sensor;
detect second temperature data from the second temperature sensor;
determine one or more temperature gradients, including a temperature gradient external to a user of the electronic device, using the first temperature data and the second temperature data;
in accordance with a determination that the one or more temperature gradients satisfy one or more first criteria, determine that the electronic device has a first orientation; and
in accordance with a determination that the one or more temperature gradients satisfy one or more second criteria, different from the first criteria, determine that the electronic device has a second orientation different from the first orientation of the electronic device.

20. The non-transitory computer readable storage medium of claim 19, wherein:
the first temperature sensor acquires the first temperature data at a first location,
the second temperature sensor acquires the second temperature data at a second location,
the one or more first criteria include a criterion that is satisfied when a set of temperature gradients of the one or more determined temperature gradients in a direction corresponding to from the first location to the second location has a positive value, and
the one or more second criteria include a criterion that is satisfied when a set of temperature gradients in the direction corresponding to from the first location to the second location has a negative value.
